(19) United States
(12) Patent Application Publication
(10) Pub. No.: US 2011/0156374 A1
(43) Pub. Date: Jun. 30, 2011

(54) REAR SUPPORT FRAME OF BABY STROLLER

(76) Inventor: PAO-HSIEN CHENG, TAINAN (TW)

(21) Appl. No.: 12/650,914

(22) Filed: Dec. 31, 2009

(51) Int. Cl. B62B 7/00

(52) U.S. Cl. 280/642

(57) ABSTRACT

A rear support frame of baby strollers is revealed. The rear support frame mainly includes a vertical rod arranged between two pivoted upper horizontal rods and two pivoted lower horizontal rods. Moreover, a connection section is arranged between a top of the vertical rod and a pivot part between the two upper horizontal rods so as to make outer ends of the upper and the lower horizontal rods are pivoted on two opposite surfaces between the two rear frames on two sides of a baby stroller. Thereby a load on the rear support frame is evenly distributed over a front surface and a rear surface of the two rear frames on two sides of the baby stroller. Thus distortion of the rear support frame is avoided and overwear of rear wheels that causes inconvenience in pushing the stroller is further prevented. The practical value of the baby stroller is enhanced.

### BACKGROUND OF THE INVENTION

1. Fields of the Invention

The present invention relates to a rear support frame of baby strollers, especially to a rear support frame of baby strollers that provides baby strollers higher strength so as to prevent distortion thereof. At the same time, overwear of rear wheels of baby strollers caused by distortion of the rear support frame can also be avoided. Thus pushing baby strollers is more convenient and energy saving for users and the practical value of baby strollers is enhanced while in use.

2. Descriptions of Related Art

When babies can't walk yet, parents always hold their babies no matter they go. Especially mothers, they always take good care of babies all the time. Thus most of parents have back pains and sore muscles around waist. While growing up, babies start to learn walking and move around with unsteady steps. In many occasions, parents still need to hold their babies in order to protect them. Or babies may get tired and sleepy after running and walking for a while and their parents got to carry babies in their arms. In order to relieves aches and pains in waist and back and release parents' loading, various kinds of baby strollers have been developed and used to carry babies. The baby stroller mainly includes a frame disposed with wheels on a bottom thereof, a seat for babies arranged at the frame and a handle pushing the stroller and disposed on top of the frame. Thus parents can push the baby stroller and move around by the wheels on the bottom of the baby stroller. Therefore, the time that parents hold their babies is shortened and discomfort or fatigue of their hands is relieved.

However, although the above baby stroller is provided to carry babies, the rear support frame disposed on a rear surface of rear frames of the baby stroller is easily deformed when the baby is seated in the stroller and their weight forms a downward load on the rear support frame. Once the rear support frame is deformed, rear wheels of the baby stroller are offset and not aligned on the same axis. Thus while pushing the baby stroller, wheels on an outer side of the rear wheels easily wear out due to uneven force distribution and the proportion of damaged wheels is increased. Moreover, the damaged wheels make pushing the baby stroller even more difficult and hard. Thus there is a need to improve the structure of baby strollers available now.

### SUMMARY OF THE INVENTION

Therefore it is a primary object of the present invention to provide a rear support frame of baby stroller in which a load is evenly distributed on a front surface and a rear surface between two rear frames on two sides of the baby stroller so as to prevent distortion of the rear support frame. Moreover, the overwear of rear wheels of the baby stroller that leads to inconvenience in pushing can be avoided. The practical value of the baby stroller is enhanced.

In order to achieve above object, a rear support frame according to the present invention includes two symmetrical upper horizontal rods whose inner ends are pivoted to each other, two symmetrical lower horizontal rods whose inner ends are pivoted to each other and a vertical rod arranged between a center pivot part of the two pivoted upper horizontal rods and a center pivot part of the two lower horizontal rods. A connection section is disposed between a top of the vertical rod and the pivot part of the two pivoted upper horizontal rods so as to make outer ends of the upper horizontal rods and outer ends of the lower horizontal rods respectively are pivoted on a front surface and a rear surface (or a rear surface and a front surface) between the two rear frames on two sides of a baby stroller. Thereby when a baby is seated in the baby stroller, a load on the rear support frame is evenly distributed over the front surface and the rear surface of the two rear frames on two sides of the baby stroller.

### BRIEF DESCRIPTION OF THE DRAWINGS

The structure and the technical means adopted by the present invention to achieve the above and other objects can be best understood by referring to the following detailed description of the preferred embodiments and the accompanying drawings, wherein:

FIG. 1 is an explosive view of an embodiment according to the present invention;

FIG. 2 is an assembly view of an embodiment according to the present invention;

FIG. 3 is a partial cross sectional view of an embodiment according to the present invention;

FIG. 4 is an assembly view of another embodiment according to the present invention;

FIG. 5 is a partial cross sectional view of another embodiment according to the present invention.

### DETAILED DESCRIPTION OF THE PREFERRED EMBODIMENT

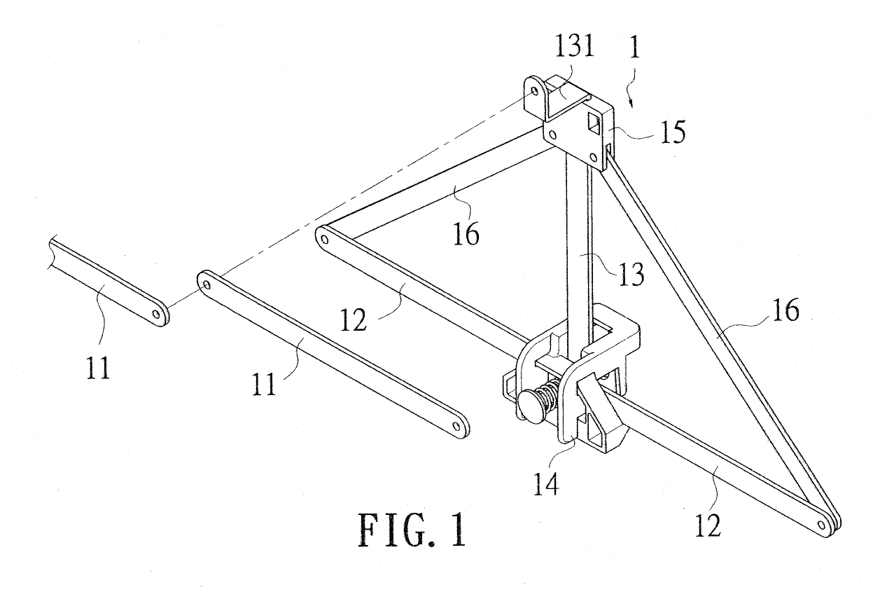

Refer to FIG. 1, a rear support frame 1 of the present invention includes two symmetrical upper horizontal rods 11 whose inner ends are pivoted to each other and two symmetrical lower horizontal rods 12 whose inner ends are pivoted to each other. A vertical rod 13 is arranged between a center pivot part of the two pivoted upper horizontal rods 11 and a center pivot part of the two lower horizontal rods 12. A connection section is located between a top of the vertical rod 13 and the pivot part of the two pivoted upper horizontal rods 11. The connection section can be a bending part 131 that is formed by bending of the top end of the vertical rod 13. A positioning device 14 is disposed between a bottom of the vertical rod 13 and the pivot part of the two lower horizontal rods 12. A moveable base 15 is disposed around the vertical rod 13 and an inclined rod 16 is pivoted on each of two sides of the moveable base 15 while the other end of the inclined rod 16 is pivoted to an outer end of the lower horizontal rod 12.

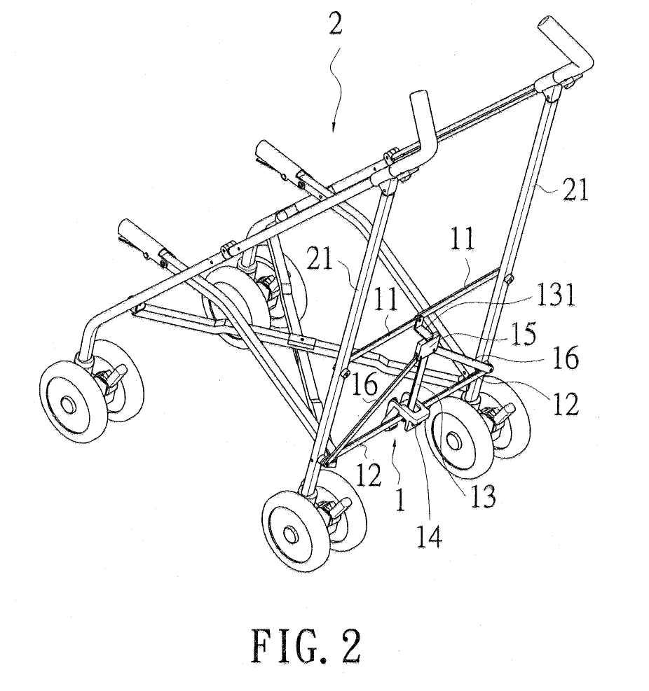

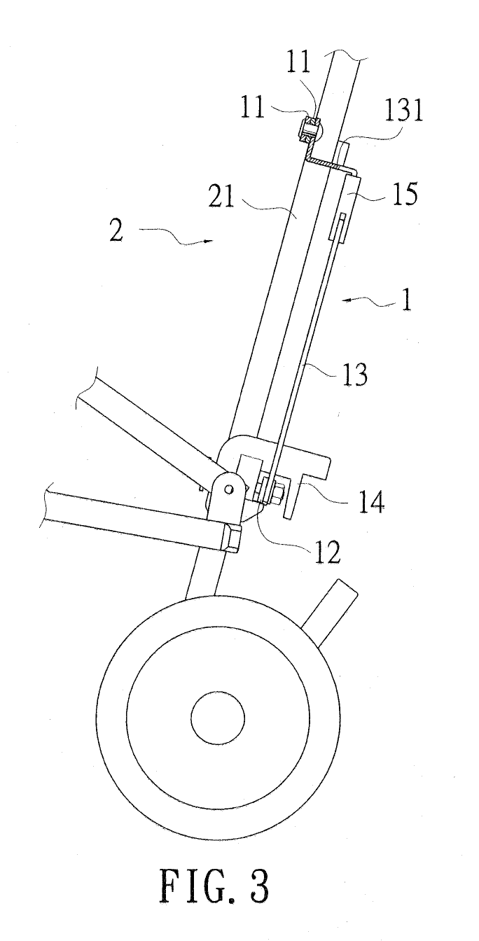

Thereby also refer to FIG. 2 and FIG. 3, the rear support frame 1 is pivoted between rear frames 21 on two sides of a baby stroller 2. Due to the connection section between the upper horizontal rods 11 and the vertical rod 13 of the rear support frame 1, outer ends of the upper horizontal rods 11 are pivoted on a front surface or a rear surface between the two rear frames 21 respectively on two sides of the baby stroller 2 while the lower horizontal rods 12 of the rear support frame 1 are pivoted on a rear surface or a front surface between the two rear frames 21, opposite and corresponding to the upper horizontal rods 11 so that a load on the rear support frame 1 is evenly distributed over the front surface and the rear surface of the two rear frames 21 on two sides of the baby stroller 2. Thus distortion of the rear support frame 1 can be avoided.

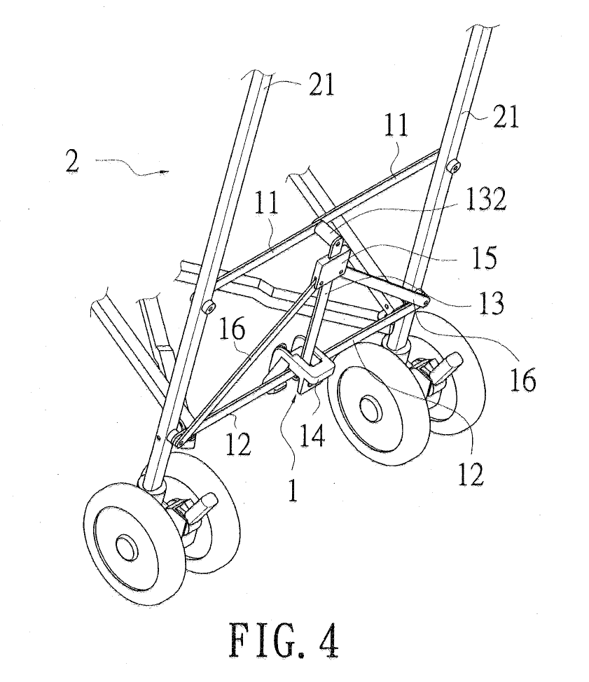

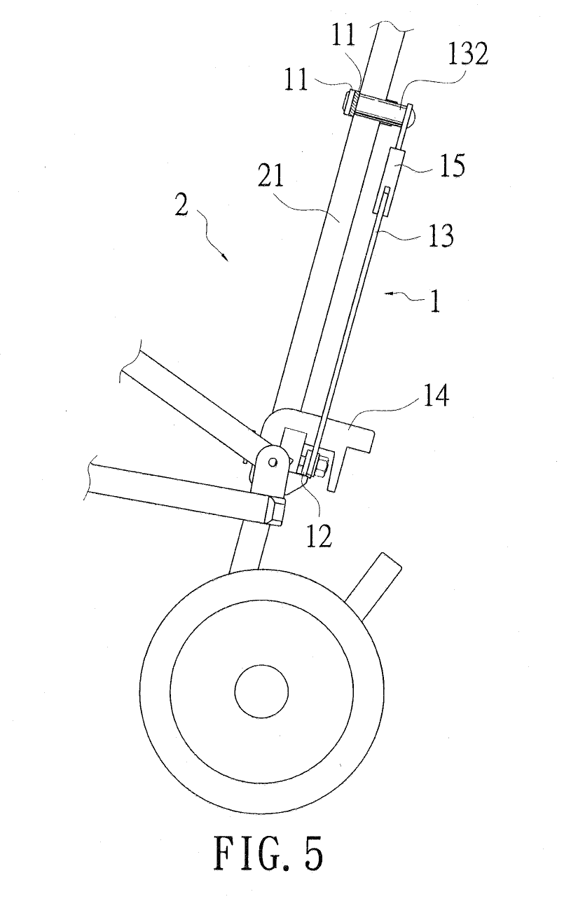

The connection section between the upper horizontal rods 11 of the rear support frame 1 and the vertical rod 13 can not only be the bending part 131 formed by bending of the top end of the vertical rod 13, as shown in FIG. 1, but also can be a washer 132 sleeved on the vertical rod 13, as shown in FIG. 4 and FIG. 5. Thus the outer ends of the upper horizontal rods 11 are pivoted on the front surface or the rear surface of the rear frames 21 while the lower horizontal rods 12 of the rear support frame 1 are pivoted on the rear surface or the front surface of the rear frames 21, opposite and corresponding to the upper horizontal rods 11. Therefore, the load on the rear support frame 1 is distributed evenly over the front surface and the rear surface of the rear frames 21 on two sides of the baby stroller 2 so as to prevent distortion of the rear support frame 1.

In summary, compared with structures available now, the present invention primarily includes a vertical rod arranged between a center pivot part of the two pivoted upper horizontal rods and a center pivot part of the two pivoted lower horizontal rods on a rear support frame. A connection section is disposed between the top of the vertical rod and the pivot part of the two upper horizontal rods 11 so that outer ends of the upper horizontal rods and outer ends of the lower horizontal rods respectively are pivoted on a front surface and a rear surface of the rear frames on two sides of a baby stroller. Or the outer ends of the upper horizontal rods and outer ends of the lower horizontal rods respectively are pivoted on a rear surface and a front surface of the rear frames on two sides of a baby stroller. The outer ends of the upper horizontal rods and outer ends of the lower horizontal rods respectively are pivoted to the surfaces that are opposite and corresponding to each other. Thus the load on the rear support frame is distributed evenly over the front surface and the rear surface of the rear frames on two sides of the baby stroller. Thus not only the support strength of the baby stroller is enhanced, the distortion of the rear support frame occurred in use can be avoided. Moreover, the overwear of rear wheels of the baby stroller caused by distortion of the rear support frame is also prevented. For users, the baby stroller is more convenient and more energy efficient. Thus the practical value of the baby stroller is enhanced while in use.

Additional advantages and modifications will readily occur to those skilled in the art. Therefore, the invention in its broader aspects is not limited to the specific details, and representative devices shown and described herein. Accordingly, various modifications may be made without departing from the spirit or scope of the general inventive concept as defined by the appended claims and their equivalents.

What is claimed is:

1. A rear support frame pivoted between rear frames on two sides of baby strollers comprising:
two upper horizontal rods whose inner ends are pivoted to each other correspondingly,
two lower horizontal rods whose inner ends are pivoted to each other correspondingly,
a vertical rod arranged between a center pivot part of the two pivoted upper horizontal rods and a center pivot part of the two lower horizontal rods, and
a connection section disposed between a top of the vertical rod and the center pivot part of the two pivoted upper horizontal rods;
wherein outer ends of the upper horizontal rods as well as outer ends of the lower horizontal rods are pivoted on two opposite surfaces, a front surface and a rear surface, between the rear frames on two sides of the baby stroller.

2. The device as claimed in claim 1, wherein the connection section between the upper horizontal rods of the rear support frame and the vertical rod is a bending part that is formed by bending of a top end of the vertical rod and is integrated with the vertical rod.

3. The device as claimed in claim 1, wherein the connection section between the upper horizontal rods of the rear support frame and the vertical rod is formed by at least a washer.

4. The device as claimed in claim 1, wherein the upper horizontal rods of the rear support frame are pivoted on a front surface between the rear frames on two sides of the baby stroller and the lower horizontal rods are pivoted on a rear surface between the rear frames on two sides of the baby stroller.

5. The device as claimed in claim 1, wherein the upper horizontal rods of the rear support frame are pivoted on a rear surface between the rear frames on two sides of the baby stroller and the lower horizontal rods are pivoted on a front surface between the rear frames on two sides of the baby stroller.
